(19) United States
(12) Patent Application Publication
(10) Pub. No.: US 2017/0373621 A1
(43) Pub. Date: Dec. 28, 2017

(54) Determining a Spin Direction of an Electric Motor

(71) Applicant: QUALCOMM Incorporated, San Diego, CA (US)

(72) Inventors: Ross Eric Kessler, Philadelphia, PA (US); Aleksandr Kushleyev, Philadelphia, PA (US); Daniel Warren Mellinger, III, Philadelphia, PA (US)

(21) Appl. No.: 15/192,448

(22) Filed: Jun. 24, 2016

(51) Int. Cl. H02P 6/30; B64C 39/02

(52) U.S. Cl. CPC H02P 6/30; B64C 39/024; B64C 2201/108; B64C 2201/042

(57) ABSTRACT

Embodiments include devices and methods for determining a spin direction of a motor of an unmanned aerial vehicle (UAV). A processor of the UAV may apply a first power to spin the motor in a first direction. The processor may select the first direction in response to determining that a detected rotational frequency-per-applied power in the first direction matches the expected rotational frequency-per-applied power. The processor may select the first direction in response to determining that a detected vertical motion is positive when the first power is applied in the first direction. The processor may also apply a second power to spin the motor in a second direction. The processor may determine whether a detected rotational frequency-per-applied power in the second direction matches the expected rotational frequency-per-applied power. The processor may determine whether a detected vertical motion is positive when the second power is applied in the second direction.

### BACKGROUND

Unmanned aerial vehicles (UAVs) commonly include multiple, such as four or more, fixed-pitch rotors driven by controllable electric motors, providing take-off, hover, and landing capabilities with a high degree of freedom. To maintain stable flight, rotor speed and direction must be carefully controlled.

Many hobbyist and research-grade multi-rotor drones use interchangeable motors, electronic speed controllers (ESCs), and propellers. However, changing a motor or ESC raises complications. It may be difficult to determine the spin direction of a motor (e.g., clockwise or counterclockwise) based only on the model or version of such motor. Installing and directly observing the spin direction of a rotor (i.e., of a motor driving the rotor) may be inconvenient, since mistakes can only be corrected by rewiring and re-soldering the motor. Further, directly observing the spin direction of rotor may be unreliable and unsafe.

### SUMMARY

Various embodiments enable an unmanned aerial vehicle (UAV) to control a motor to determine a spin direction of the motor. Various embodiments may include applying a first power to a motor of the UAV in a first direction, detecting a rotational frequency-per-applied power of the motor in response to applying the first power in the first direction, determining whether the detected rotational frequency-per-applied power in the first direction matches an expected rotational frequency-per-applied power within a specified tolerance, and selecting the first direction in response to determining that the detected rotational frequency-per-applied power in the first direction matches the expected rotational frequency-per-applied power within the specified tolerance.

Some embodiments may further include applying a second power to the motor in a second direction, and detecting a rotational frequency-per-applied power of the motor in response to applying the second power in the second direction. In such embodiments, determining whether the detected rotational frequency-per-applied power in the first direction matches an expected rotational frequency-per-applied may include determining which of the detected rotational frequency-per-applied power in the first direction and the detected rotational frequency-per-applied power in the second direction is a closer match to the expected rotational frequency-per-applied power. Also in such embodiments, selecting the first direction in response to determining that the detected rotational frequency-per-applied power in the first direction matches the expected rotational frequency-per-applied power may include selecting the direction of the closer match of the detected rotational frequency-per-applied power in the first direction and the detected rotational frequency-per-applied power in the second direction to the expected rotational frequency-per-applied power. Some embodiments may further include determining whether a closer match is determinable, and applying first power to the motor in the first direction in response to determining that the closer match is not determinable.

Some embodiments may further include detecting that a new motor is coupled to the UAV, and detecting a model of the new motor when the new motor is detected, wherein the expected rotational frequency-per-applied power is based on the detected model of the motor. Some embodiments may further include detecting a model of the motor when the new motor is detected, wherein the expected rotational frequency-per-applied power may be based on the detected model of the motor. Some embodiments may further include storing the selected direction in a memory, retrieving the stored direction from the memory, and applying power to the motor based on the retrieved direction. In some embodiments, the memory may include a memory of the UAV. In some embodiments, the memory may include a memory of a wireless device associated with the UAV. Some embodiments may further include applying power to the motor using the selected direction, analyzing the motor spin direction in response to applying the power to the motor, and determining whether the motor is spinning in a correct direction that correlates with an expected spin direction based on the analyzed motor spin direction.

Various embodiments may include applying a first power to a motor of the UAV in a first direction, detecting a vertical motion in response to applying the first power in the first direction, determining whether the detected vertical motion is positive when the first power is applied in the first direction, and selecting the first direction in response to determining that the detected vertical motion is positive when the first power is applied in the first direction. Some embodiments may further include applying a second power to the motor in a second direction, detecting a vertical motion in response to applying the second power in the second direction, determining whether the detected vertical motion is positive when the second power is applied in the second direction in response to determining that the vertical motion is not positive when the first power is applied in the first direction, and selecting the second direction in response to determining that the detected vertical motion is positive when the second power is applied in the second direction.

Some embodiments may further include applying the first power to the motor in the first direction in response to determining that the vertical motion is not positive when the power is applied in the second direction. Some embodiments may further include storing the selected direction in a memory, retrieving the stored direction during a power-up of the UAV, and applying power to the motor using the retrieved direction. In some embodiments, the memory may include a memory of the UAV. In some embodiments, the memory may include a memory of a wireless device associated with the UAV.

Some embodiments may further include detecting that a new motor is coupled to the UAV, and detecting a model of the new motor when the new motor is detected, wherein determining whether the detected vertical motion is positive when the first power is applied in the first direction may be based on the detected model of the motor. Some embodiments may further include detecting a model of the motor when the new motor is detected, wherein determining whether the detected vertical motion is positive when the first power is applied in the first direction may be based on the detected model of the motor. Some embodiments may further include applying power to the motor using the selected direction, analyzing the motor spin direction in response to applying the power to the motor in response to applying the power to the motor, and determining whether the motor is spinning in a correct direction that correlates with an expected spin direction based on the analyzed motor spin direction.

Various embodiments include a UAV including a motor and a processor coupled to the motor and configured with processor-executable instructions to perform operations of the aspect methods described above. Various embodiments also include a non-transitory processor-readable storage medium having stored thereon processor-executable software instructions configured to cause a processor to perform operations of the aspect methods described above. Various embodiments also include a UAV that includes means for performing functions of the operations of the aspect methods described above.

### BRIEF DESCRIPTION OF THE DRAWINGS

The accompanying drawings, which are incorporated herein and constitute part of this specification, illustrate example embodiments, and together with the general description given above and the detailed description given below, serve to explain the features of various embodiments.

FIG. 1 is a top view of a UAV according to various embodiments.

FIG. 2A is a component block diagram illustrating components of a UAV according to various embodiments.

FIG. 2B is a component block diagram illustrating components of motor controller and motor according to various embodiments.

FIG. 3 is a process flow diagram illustrating a method of determining a spin direction of a motor of a UAV according to various embodiments.

FIG. 4 is a diagram illustrating thrust and drag of a rotor in various directions of rotation.

FIG. 5 is a rotational frequency-per-applied power plot of a motor when spun in a first direction and a second direction.

FIG. 6 is a process flow diagram illustrating a method of determining a spin direction of a motor of a UAV according to various embodiments.

FIG. 7 is a diagram illustrating thrust and lift of a rotor in various directions of rotation.

FIG. 8 is a diagram illustrating a positive motion of direction of a motor of the UAV.

FIG. 9 is a diagram illustrating a negative motion of direction of a motor of the UAV.

FIG. 10 is a process flow diagram illustrating a method of verifying a spin direction of a motor of a UAV according to various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and embodiments are for illustrative purposes, and are not intended to limit the scope of the claims.

Various embodiments provide methods implemented by a processor in a UAV for determining a spin direction of a motor of a UAV when power is applied to the motor. The UAV may include (at least) two processors, a first processor associated with the ESC (an “ESC processor”) and a second processor that is a main or central processor or motor/flight controller of the UAV (a “main processor”). In some embodiments, the central processor and the motor/flight controller may be the same processor, distinct from the ESC processor. In some embodiments, each of the central processor and the motor/flight controller may be separate (or distinct) processors, each distinct from the ESC processor. In some embodiments, a UAV may include an ESC processor in communication with each of a plurality of motors. In some embodiments, one ESC processor may be in communication with the motors of the UAV. In some embodiments, each motor may be in communication with a separate ESC processor. As used herein, the term “processor” refers to one or more processors of the UAV, including any ESC processor, the main processor, and other processors of the UAV.

As used herein, the term “UAV” refers to one of various types of unmanned aerial vehicle. A UAV may include an onboard computing device configured to fly and/or operate the UAV without remote operating instructions (i.e., autonomously), such as from a human operator or remote computing device. Alternatively, the onboard computing device may be configured to fly and/or operate the UAV with some remote operating instruction or updates to instructions stored in a memory of the onboard computing device. A UAV may be propelled for flight using a plurality of propulsion units, each including one or more rotors, that provide propulsion and/or lifting forces for the UAV. In addition, a UAV may include wheels, tank-tread, or other non-aerial movement mechanisms to enable movement on the ground. UAV propulsion units may be powered by one or more types of electric power sources, such as batteries, fuel cells, motor-generators, solar cells, or other sources of electric power, which may also power the onboard computing device, navigation components, and/or other onboard components.

The term “computing device” is used herein to refer to an electronic device equipped with at least a processor that may be configured with processor-executable instructions. Examples of computing devices may include UAV flight control and/or mission management computer that are onboard the UAV, as well as remote computing devices communicating with the UAV configured to perform operations of various embodiments. Remote computing devices may include wireless communication devices (e.g., cellular telephones, wearable devices, smart-phones, web-pads, tablet computers, Internet enabled cellular telephones, Wi-Fi enabled electronic devices, personal data assistants (PDAs), laptop computers, etc.), personal computers, and servers. In various embodiments, computing devices may be configured with memory and/or storage as well as wireless communication capabilities, such as network transceiver(s) and antenna(s) configured to establish a wide area network (WAN) connection (e.g., a cellular network connection, etc.) and/or a local area network (LAN) connection (e.g., a wireless connection to the Internet via a Wi-Fi router, etc.).

UAVs (also referred to as “drones”) are commonly used in a variety of applications, including surveying, photography, power or communications repeater functions, and delivery, among other things. Many hobbyist and research grade UAVs (e.g., quadrotors) use interchangeable motors, electronic speed controllers (ESCs), and propellers. To rotate a motor (and thus the attached rotor) in a particular direction (e.g., clockwise or counterclockwise), an ESC applies a voltage to each of the electrical leads connected to three phases of the motor in a particular sequence depending upon how the windings of the motor are configured.

When a UAV motor is replaced, the new motor must be properly wired to ensure that it spins in the proper direction for flight. However, the proper connection of the wires of various models of motor may neither be uniform nor intuitive, and the wires of a new motor may be connected incorrectly. A user may find it difficult or impossible to determine the spin direction of a motor based only on the model or version of such motor. While some motor models utilize polarized motor connectors, the same problem arises when interchangeable ESCs are used. Installing and directly observing the spin direction of a rotor (i.e., of a motor driving the rotor) may be inconvenient, since mistakes can only be corrected by disassembly, rewiring and/or re-soldering the motor. In addition, most UAV motors spin so rapidly that visual determination (by a user) of the spin direction may be difficult and may not be safe.

Various embodiments include a method of determining a spin direction of a motor of a UAV. In some embodiments, a processor (e.g., any ESC processor, main processor, or other processor of the UAV) of the UAV may enter into a mode for detecting the spin direction of the motor when the processor detects that a new motor has been coupled to the UAV. In some embodiments, the processor may detect a model of the newly detected motor based on information received by the processor from the motor.

In various embodiments, the processor may apply power to the motor in a first direction and/or a second direction, and the processor may detect a rotational frequency-per-applied power in the first and/or second directions. For example, the processor may detect a number of revolutions per minute (RPM) generated at the motor in the first and/or second directions when a power is applied. The applied power may be a known and constant applied power in some embodiments.

The processor may compare the rotational frequency-per-applied power generated in the first and/or second directions to an expected rotational frequency-per-applied power. In some embodiments, the expected rotational frequency-per-applied power may be based on the detected model of the motor. The processor may determine which of the detected rotational frequency-per-applied power in the first direction and the rotational frequency-per-applied power in the second direction is a closer match to the expected frequency-per-applied power. For example, the processor may determine that one of the detected rotational frequency-per-applied powers includes one or more characteristics that are closer to the expected rotational frequency-per-applied power than the other rotational frequency-per-applied power. The processor may determine whether it is able to determine a closer match, and if a closer match is determinable, the processor may select the direction for which the generated rotational frequency-per-applied power (i.e., the first or second direction) is a closer match to the expected rotational frequency-per-applied power.

In various embodiments, the processor may apply power to the motor in a first direction and/or a second direction, and the processor may detect a vertical motion of the motor (or of the UAV) as power is applied in the first and/or second directions. In some embodiments, the processor may receive information from an inertial measurement unit (IMU) of the UAV, which may include one or more accelerometers and/or gyroscopes, as power is applied in the first and/or second directions. The processor may determine a vertical motion of the motor (or of the UAV) as power is applied in the first and/or second directions.

In some embodiments, the vertical motion may include a positive or downward vertical motion of the motor or UAV. In some embodiments, the processor may correlate the determined vertical motion with a direction of lift generated by a rotor coupled to the motor as the processor applies power in the first and/or second directions. The processor may select the direction in which the detected vertical motion is positive (e.g., may select the direction that results in generating positive lift).

In some embodiments, the processor may also perform an error-checking process to verify the selected motor direction.

In some embodiments, the processor may store the selected direction in memory for use during operation. Then, during a subsequent power-up of the UAV, the processor may retrieve the stored direction and apply power to the motor according to the retrieved stored direction.

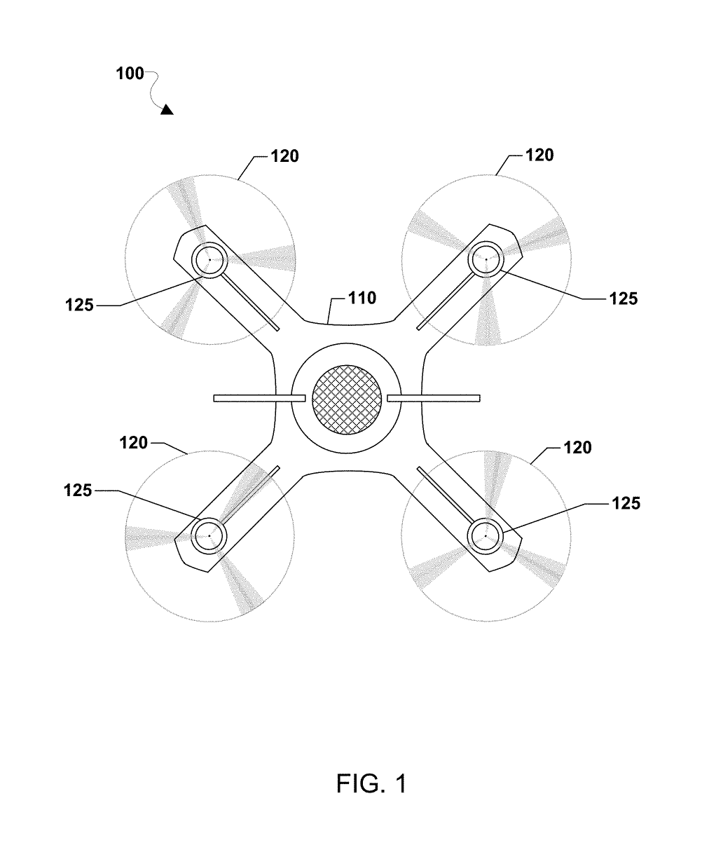

Various embodiments may be implemented within a variety of UAVs 100, an example of which is illustrated in FIG. 1. With reference to FIG. 1, the UAV 100 may include a plurality of rotors 120 supported by a frame 110. The rotors 120 may each be associated with a motor 125. The motor 125 may be a three-phase alternating current (AC) motor or another multi-phase configuration of motor.

While the UAV 100 is illustrated with four rotors 120, various embodiments may include more or fewer rotors 120. For conciseness of description and illustration, some detailed aspects of the UAV 100 are omitted such as wiring, frame structure interconnects or other features that would be known to one of skill in the art. For example, the UAV 100 may be constructed with an internal frame having a number of support structures or using a molded frame in which support is obtained through the molded structure.

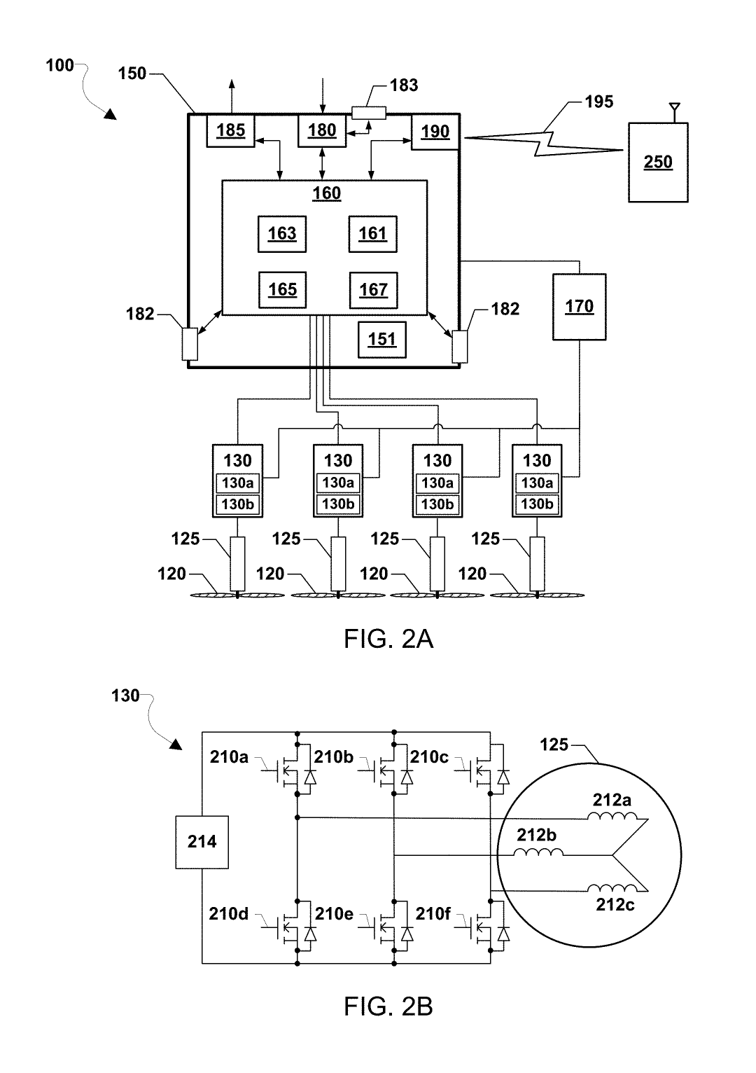

FIG. 2A is a component block diagram illustrating components of the UAV 100 according to various embodiments. With reference to FIGS. 1 and 2A, the UAV 100 may include a control unit 150 that may include various circuits and devices used to power and control the operation of the UAV 100. For example, the control unit 150 may include a processor 160 configured with processor-executable instructions to control flight and other operations of the UAV 100, including operations of various embodiments. The control unit 150 may be coupled to each of the rotors 120 by way of the corresponding motors 125. Optionally, each of the motors 125 may communicate with a controller 130 (e.g., an ESC controller) that may handle functions including controlling aspects of the operation of the ESCs associated motor 125. Each controller 130 may include a processor 130a (ESC processor) configured to execute processor-executable instructions that may be stored in a memory 130b.

FIG. 2B is a component block diagram illustrating components of a controller (e.g., 130) and a motor (e.g., 125). With reference to FIGS. 1-2B, in some embodiments, each controller 130 may include six metal-oxide semiconductor field-effect transistor (MOSFETs) 210a, 210b, 210c, 210d, 210e, 210f coupled to motor windings 212a, 212b, 212c of each motor 125. Each controller 130 may also include feedback circuitry 214 coupled to each of the MOSFETs 210a, 210b, 210c, 210d, 210e, 210f and to the processor 130a.

The processor 160 or the controllers 130 may control power to the motors 125 to drive each of the rotors 120. The processor 160 or the controllers 130 may drive the motors 125 “forward” to generate varying amounts of auxiliary thrust, or “backward” to produce varying amounts of mixed aerodynamic forces. The UAV 100 may also include an onboard battery 170, which may be coupled to the motors 125 (e.g., via controllers 130) and the control unit 150. Each of the controllers 130 may be used to control individual speeds of the motors 125.

The control unit 150 may include a power module 151, an input module 180, one or more sensors 182, an output module 185, a radio module 190, each coupled to the processor 160. The processor 160 may include or be coupled to a memory 161 and a navigation unit 163. The control unit 150 may be coupled to a payload-securing unit (not shown) that may include an actuator motor that drives a gripping and release mechanism and related controls that grip and release a payload in response to commands from the control unit 150.

The sensors 182 may be optical sensors, radio sensors, a camera, and/or other sensors. Alternatively or additionally, the sensors 182 may be contact or pressure sensors that may provide a signal that indicates when the UAV 100 has landed. The power module 151 may include one or more batteries that may provide power to various components, including the processor 160, the input module 180, the sensors 182, the output module 185, and the radio module 190. The onboard battery 170 may include energy storage components, such as rechargeable batteries.

Through control of individual ones of the motors 125 corresponding to each of the rotors 120, the UAV 100 may be controlled in flight as the UAV 100 progresses toward a destination and/or operates in various flight modes. The processor 160 may receive data from the navigation unit 163 and use such data in order to determine the present position and orientation of the UAV 100, as well as the appropriate course towards the destination or landing sites. In various embodiments, the navigation unit 163 may include a global navigation satellite system (GNSS) receiver system (e.g., one or more Global Positioning System (GPS) receivers) enabling the UAV 100 to navigate using GNSS signals. Alternatively or in addition, the navigation unit 163 may be equipped with radio navigation receivers for receiving navigation beacons or other signals from radio nodes, such as navigation beacons (e.g., very high frequency (VHF) Omni Directional Radio Range (VOR) beacons), Wi-Fi access points, cellular network sites, radio station, remote computing devices, other UAVs, etc.

The processor 160 and/or the navigation unit 163 may be configured to communicate with a server through a wireless connection (e.g., a cellular data network) to receive commands to control flight, receive data useful in navigation, provide real-time position altitude reports, and assess data. An avionics module 167 coupled to the processor 160 and/or the navigation unit 163 may be configured to provide flight control-related information such as altitude, attitude, airspeed, heading and similar information that the navigation unit 163 may use for navigation purposes, such as dead reckoning between GNSS position updates. The avionics module 167 may include or receive data from a gyro/accelerometer unit 165 that provides data regarding the orientation and accelerations of the UAV 100 that may be used in navigation and positioning calculations.

The radio module 190 may be configured to receive signals, such as command signals for controlling flight protocol, receive signals from aviation navigation facilities, etc., and provide such signals to the processor 160 and/or the navigation unit 163 to assist in UAV operation. In some embodiments, the radio module 190 may enable the UAV 100 to communicate with a wireless communication device 250 through a wireless communication link 195. The wireless communication link 195 may be a bi-directional communication link or a unidirectional communication link (e.g., using Spektrum 2.4 GHz digital spectrum modulation).

In some embodiments, the UAV 100 may receive an activation signal from the wireless communication device 250 via the radio module 190 to place the UAV 100 into a mode in which the UAV 100 may determine a spin direction of one or more of the motors 125. In some embodiments, the UAV 100 may also receive information from the wireless communication device 250 indicating, or enabling the processor 160 to determine, the spin direction of one or more of the motors 125.

In various embodiments, the control unit 150 may be equipped with the input module 180, which may be used for a variety of applications. For example, the input module 180 may receive input from a button or switch 183, for example, to place the UAV 100 into a mode in which the UAV 100 may determine a spin direction of one or more of the motors 125. The input module 180 may also receive images or data from an onboard camera or sensor (e.g., 182) and/or may receive electronic signals from other components (e.g., a payload). The output module 185 may be used to activate components (e.g., an energy cell, an actuator, an indicator, a circuit element, a sensor, and/or an energy-harvesting element).

While various components of the control unit 150 are illustrated or described as separate components, some or all of the components (e.g., the processor 160, the output module 185, the radio module 190, and other units) may be integrated together in a single device or module, such as a system-on-chip module.

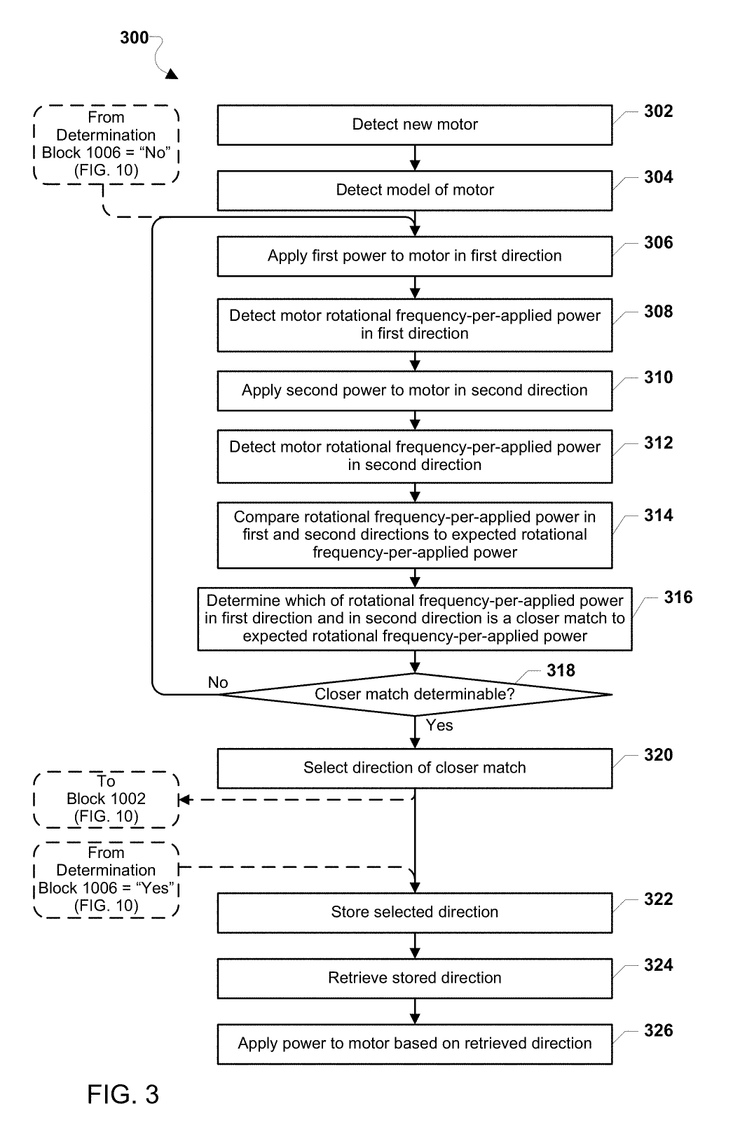

FIG. 3 illustrates a method 300 of determining a spin direction of a motor (e.g., 125 in FIGS. 1-2B) of a UAV (e.g., 100 in FIGS. 1-2A) according to various embodiments. With reference to FIGS. 1-3, the method 300 may be implemented by a processor (e.g., the processor 160, the processor 130a, and/or the like) of the UAV.

In block 302, the processor may detect that a new motor has been coupled to the UAV (e.g., a motor has been replaced or newly installed). For example, the processor may receive information electronically from a newly installed motor, such as a unique identifier, and the processor may identify the motor as newly installed. In some embodiments, the processor may enter into a mode for detecting the spin direction of the motor when the processor detects the new motor.

In some embodiments, the processor may enter the mode for detecting the spin direction of the motor based on a user input, which may be received at the UAV (e.g., at the button or switch 183) or from the wireless device 250. In some/other embodiments, the processor need not detect that a new motor has been coupled to begin the method. It may do so periodically (e.g., daily, weekly, monthly, etc.) or in response to some event (e.g., in response to a user input, powering up the UAV, etc.).

In block 304, the processor may detect a model of the motor based on information received by the processor from the motor. For example, the processor may receive information electronically, such as a model number, a part number, or another unique identifier, from the motor. Detecting the model may enable the processor to determine an expected rotational frequency-per-applied power of the motor.

In some embodiments, the information used by the processor to detect the model may be the same information that the processor uses to detect that the motor is new. In some embodiments, the model information may be included in or a part of other information. In some embodiments, the processor may correlate information with, for example, a look-up table or another data source, to detect the model of the motor. In other embodiments, the processor may receive information from an alternative source (e.g., user-provided information, downloaded from a remote device/server, etc.)

In block 306, the processor may apply first power to the motor in a first direction. In some embodiments, the processor may apply the first power to the motor at a constant power level for a period of time. In some embodiments, the processor may apply the first power to the motor at two or more discrete constant power levels, or across a range of power levels, over a period of time. In some embodiments, the processor may select the first power based on the detected model of the motor.

In some embodiments, the processor may also perform the operations of block 306 upon returning from determination block 1006=“No,” as further described herein (FIG. 10).

In block 308, the processor may detect a rotational frequency-per-applied power of the motor at each power level applied in the first direction. The rotational frequency may be measured in RPM or in another unit of rotational frequency.

In block 310, the processor may apply second power to the motor in a second direction (i.e., the opposite direction). For example, if applying the first power in the first direction resulted in a “clockwise” spin of the rotor, applying the second power in the second direction will result in a “counter-clockwise” spin of the rotor, and vice versa. In some embodiments, the processor may apply the second power to the motor at a constant power level, at two or more discrete constant power levels, or across a range of power levels, over time.

In block 312, the processor may detect a rotational frequency-per-applied power of the motor at each power level applied in the second direction.

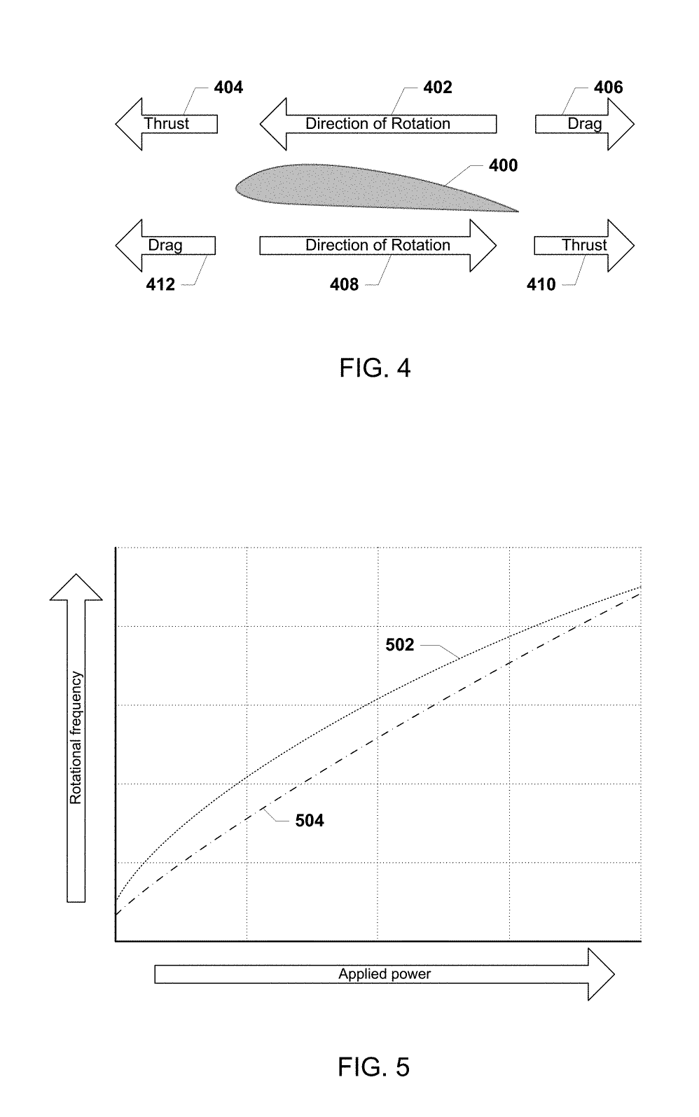

As an example, with reference to FIGS. 1-5, the processor may apply the first power to a motor to rotate a rotor 400 (which may correspond to the rotor 125) in a first direction of rotation 402, generating a thrust force 404, while aerodynamic properties of the rotor 400 generate a drag force 406. The processor may then apply the second power to the motor to rotate the rotor 400 in the opposite direction of rotation 408, which generates a thrust force 410 and a drag force 412. The aerodynamic properties of the rotor 400 will cause the thrust 404 and the drag 406 forces associated with rotation in the first direction to be measurably different from the thrust 410 and drag 412 forces associated with rotation in the second direction.

As a result, at various applied power levels the rotational frequency in the first direction and the second direction will typically be measurably different. Curve 502 illustrates rotational frequencies measured by the processor at various applied power levels in a first direction. Curve 504 illustrates rotational frequencies measured by the processor at various applied power levels in a second direction. If the curves 502 and/or 504 are known for a particular model of motor, the processor may detect the spin direction of the rotor induced by an applied power direction by comparing measured rotational frequencies at different applied power levels to the known curves.

In block 314, the processor may compare the rotational frequency-per-applied power detected in the first and second directions to an expected rotational frequency-per-applied power of the motor. In some embodiments, the expected rotational frequency-per-applied power may be based on the detected model of the motor. In some embodiments, the processor may compare the expected rotational frequency-per-applied power to the rotational frequencies in the first and second directions that result from applying a constant power level, at two or more discrete constant power levels, or across a range of power levels (e.g., the curves 502 and 504).

In some embodiments, the processor may determine, or adjust a value for, the expected rotational frequency-per-applied power based on a detected condition. For example, the processor may determine (or adjust the value for) the expected rotational frequency-per-applied power based on one or more external conditions, such as air temperature, humidity, or elevation. The processor may also determine (or adjust the value for) the expected rotational frequency-per-applied power based on one or more conditions of the UAV that may affect the detected rotational frequency-per-applied power in the first and/or second directions, such as a battery power level. In some embodiments, the expected rotational frequency-per-applied power may be based on the detected model of the motor. In some embodiments, the processor may determine the expected rotational frequency-per-applied power from a database, a lookup table, or another data structure.

In block 316, the processor may determine which of the detected rotational frequency-per-applied power in the first direction and the rotational frequency-per-applied power in the second direction is a closer match to the expected frequency-per-applied power. In some embodiments, the processor may compare one or more differences between the detected rotational frequency-per-applied power in the first direction and the rotational frequency-per-applied power in the second direction, and the processor may attempt to determine whether one of the detected rotational frequency-per-applied powers is a closer match to the expected rotational frequency-per-applied power. For example, the processor may determine that one of the detected rotational frequency-per-applied powers includes one or more characteristics that are closer to the expected rotational frequency-per-applied power than the other rotational frequency-per-applied power.

In some embodiments, one of the detected rotational frequency-per-applied power in the first direction and the second direction may match the expected rotational frequency-per-applied power sufficiently closely (e.g., within a specified tolerance, range, or threshold) so that the processor may determine that one of the detected rotational frequency-per-applied powers is a match without considering the other detected rotational frequency-per-applied power. Thus, in some embodiments, the processor may determine whether a detected rotational frequency-per-applied power in a first direction (which may be either of the first or second direction) matches the expected rotational frequency-per-applied power, and the processor may select the first direction in response to determining that the detected rotational frequency-per-applied power in the first direction matches the expected rotational frequency-per-applied power.

In determination block 318, the processor may determine whether a closer match is determinable, for example, based on the detected rotational frequency-per-applied power in the first and second directions. In response to determining that a closer match is not determinable (i.e., determination block 318=“No”), the processor may again apply a first power to the motor in the first direction in block 306 and repeat one or more of blocks 308-318). In some embodiments, the first power (and/or the second power) being applied in this iteration may be a different amount (e.g., more or less) than previously applied.

In response to determining that a closer match is determinable (i.e., determination block 316=“Yes”), the processor may select the direction for which the generated rotational frequency-per-applied power is a closer match to the expected rotational frequency-per-applied power (i.e., the first or second direction) in block 320.

In some embodiments, the processor may begin an error-checking process in block 1002, further described herein (e.g., FIG. 10). In such optional embodiments, the processor may return to block 322 from determination block 1006=“Yes” (FIG. 10).

In block 322, the processor may store the selected direction in a memory (e.g., the memory 130b and/or the memory 161). In some embodiments, the selected direction may be stored in a memory remote from the UAV, such as a memory of the wireless device 250 or another remote device memory.

In block 324, the processor may retrieve the stored direction, for example, during or in response to a subsequent power-up of the UAV or other suitable time/event.

In block 326, the processor may apply power to the motor based on the retrieved stored direction.

The method 300 (or blocks thereof) may be repeated for one or more additional motors of the UAV.

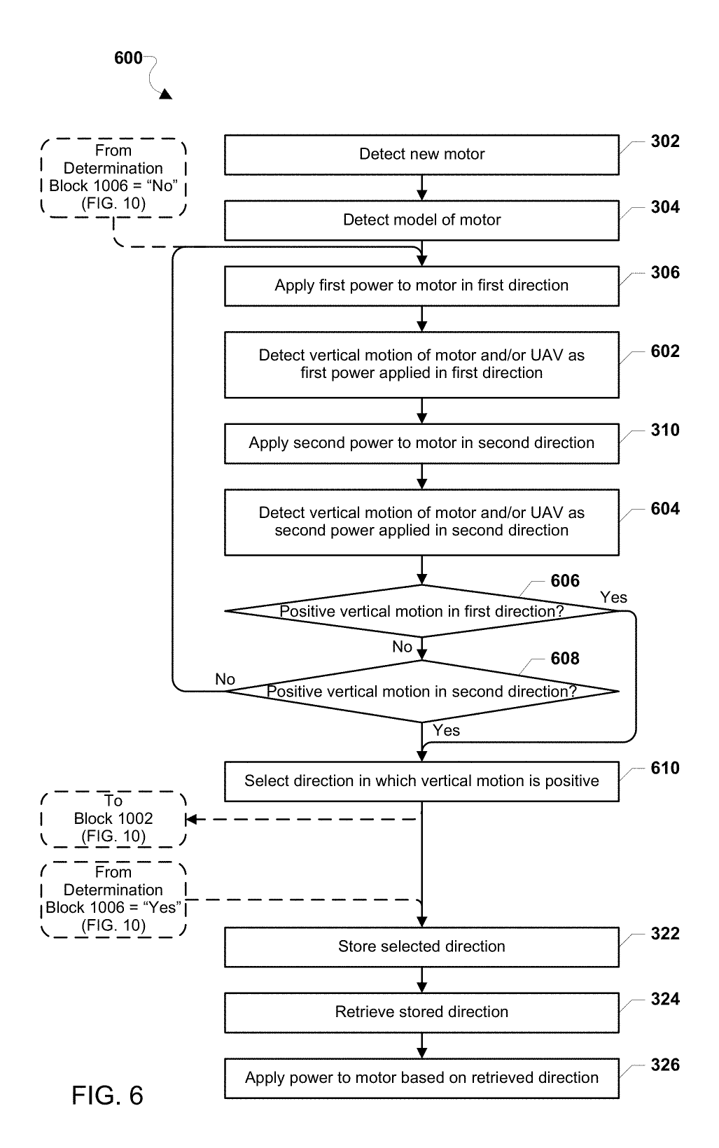

FIG. 6 illustrates a method 600 of determining a spin direction of a motor (e.g., 125 in FIGS. 1-2B) of a UAV (e.g., 100 in FIGS. 1-2A) according to various embodiments. With reference to FIGS. 1-6, the method 600 may be implemented by a processor (e.g., the processor 160, the processor 130a, and/or the like) of the UAV. In blocks 302-326, the device processor may perform operations of like numbered blocks of the method 302-326, the processor may perform operations of like numbered blocks of the method 300.

In block 602, the processor may detect a vertical motion of the motor and/or the UAV as the first power is applied in the first direction. In some embodiments, the processor may receive sensor information from an IMU (which may include an accelerometer, a gyroscope, an inertial sensor, and/or another similar sensor), and the processor may detect the vertical motion based on the sensor information.

In block 604, the processor may detect a vertical motion of the motor and/or the UAV as the second power is applied in the second direction. In some embodiments, the processor may detect the vertical motion based on sensor information.

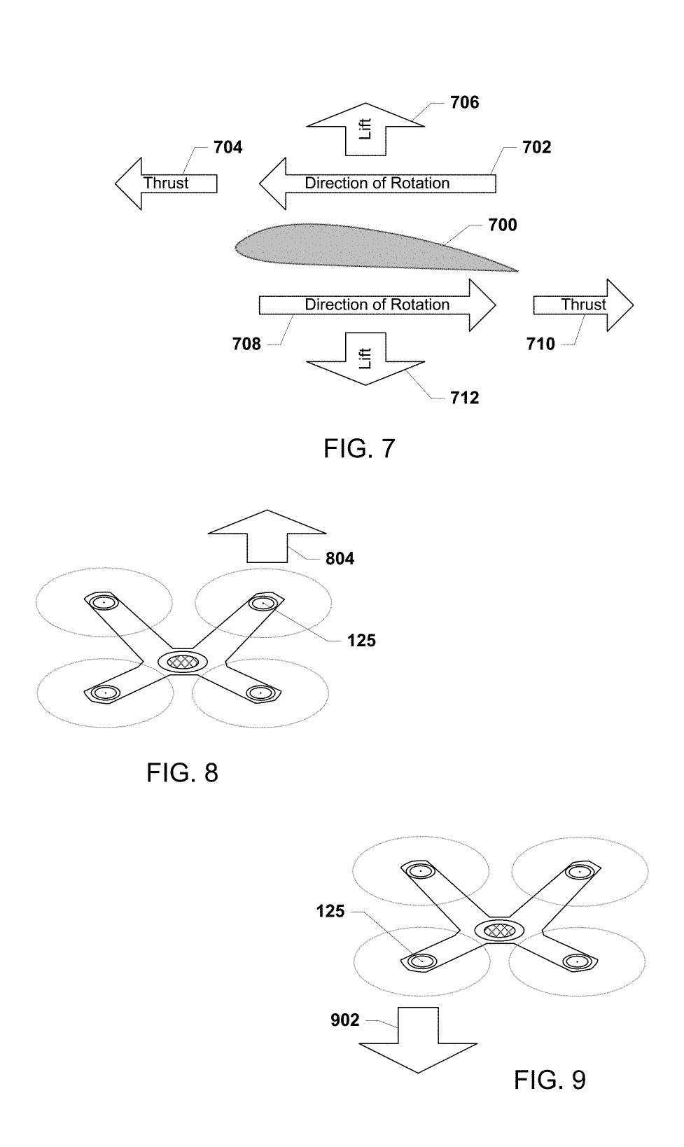

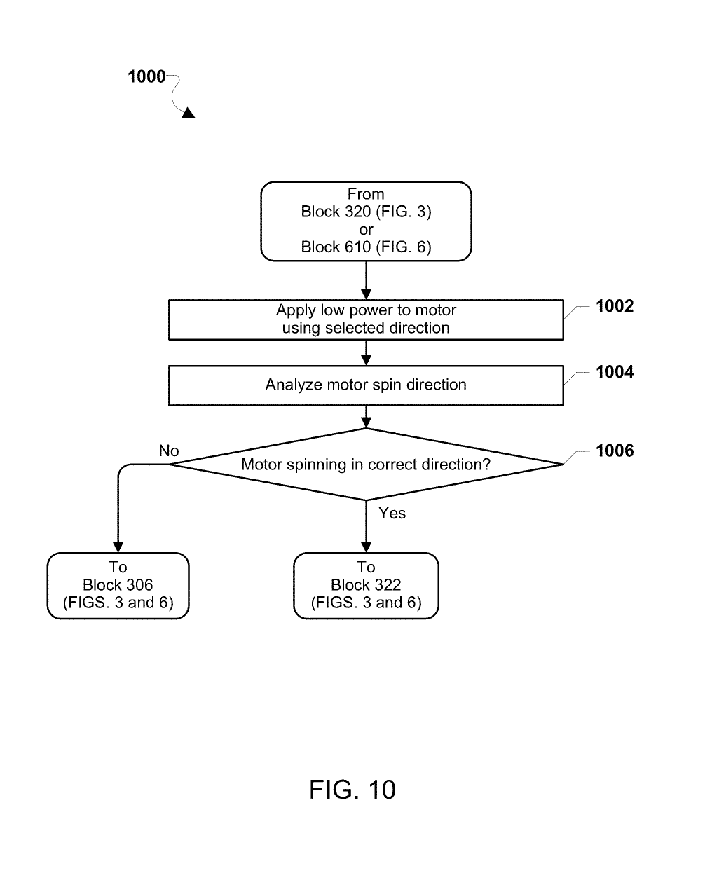

As an example, with reference to FIGS. 1-9, the processor may apply the first power to a motor to rotate the rotor 700 in a first direction of rotation 702, generating a thrust force 704, resulting in the generation of positive lift 706.

The positive lift 706 may impart a vertical upward force 804 on the motor 125. The processor may detect information indicating the positive lift 706 and/or the vertical upward force 804, such as a change in orientation of the UAV, a change in the position of the motor 125, a rotational motion of the UAV (e.g., due to torque from the motor), or other information. In some embodiments, a detection of the positive lift 706 and/or the vertical upward force 804 may be based on the detected model of the motor. For example, the processor may set or adjust a detection threshold (such as a threshold level of positive lift, vertical upward force, and/or distance that the vertical force moves or rotates the motor and/or UAV).

The processor may apply the second power to the motor to rotate the rotor 700 in a second direction of rotation 708, which generates a thrust force 710, resulting in the generation of a downward thrust 712.

The downward thrust 712 may impart a vertical downward force 902 on motor 125. The processor may detect information indicating the downward thrust 712 and/or the vertical downward force 902. In some embodiments, the detection of the downward thrust 712 and/or the vertical downward force 902 may be based on the detected model of the motor. For example, the processor may set or adjust a detection threshold (such as a threshold level of positive lift, vertical upward force, and/or distance that the vertical force moves or rotates the motor and/or UAV).

In determination block 606, the processor may determine whether upward vertical motion is detected by the processor when the processor applies the first power to the motor in the first direction.

In response to determining that upward vertical motion is not detected by the processor when the processor applies power to the motor in the first direction (i.e., determination block 606=“No”), the processor may determine whether upward vertical motion is detected by the processor when the processor applies the second power to the motor in the second direction in determination block 608.

In response to determining that upward vertical motion is not detected by the processor when the processor applies the second power to the motor in the second direction (i.e., determination block 608=“No”), the processor may again apply the first power to the motor in the first direction in block 306. In some embodiments, the first power (and/or the second power) being applied in this iteration may be a different amount (e.g., more or less) than previously applied.

In response to determining that upward vertical motion is detected by the processor when the processor applies power to the motor in the first direction (i.e., determination block 606=“Yes”), or in response to determining that upward vertical motion is detected by the processor when the processor applies power to the motor in the second direction (i.e., determination block 608=“Yes”), the processor may select the direction for which the upward vertical motion is detected (i.e., the first or second direction) in block 610.

The method 600 (or blocks thereof) may be repeated for one or more additional motors of the UAV.

In some optional embodiments, the processor may begin an error-checking process in block 1002, as described herein (e.g., FIG. 10). In such optional embodiments, the processor may return to block 322 from determination block 1006=“Yes” (FIG. 10).

FIG. 10 illustrates a method 1000 of performing an error-checking process for determining a spin direction of a motor of a UAV according to various embodiments. With reference to FIGS. 1-10, the method 1000 may be implemented by a processor (e.g., the processor 160, the processor 130a, and/or the like) of the UAV.

In block 1002, the processor may apply power to the motor using the selected direction. In some embodiments, the processor may apply a relatively low power that may be a fraction of the motor's full power. In some embodiments, the applied power may be sufficiently low to generate a certain rotational frequency threshold, for example, of 10 RPM or less. In such cases, a user may perform a visual inspection of the rotor to determine whether the motor is spinning in the correct direction, and may provide an input to the UAV (e.g., via the button or switch 183) or to the wireless communication device 250 that the motor is spinning in the correct direction. In other embodiments, other thresholds may be selected (e.g., 15 RPM or less, 20 RPM or less, 60 RPM or less, etc.), for instance, that allow a user to accurately perform a visual inspection of the direction the rotor is spinning

In block 1004, the processor may analyze the motor spin direction. In some embodiments, the processor may receive information from an external device, such as the wireless device 250, and the processor may analyze the motor spin direction based on the received information. For example, the wireless device 250 may use a camera or another optical capture device to capture a time-stamped series of images or video of a rotor spinning (caused to spin by the based on the spinning motor). The processor may analyze the captured series of images or video to determine, for example, a sequence of rotor positions over time. In some embodiments, a detectable feature (e.g., a marking, a decal, and/or the like) may be provided on the rotor (e.g., on one or more propellers of the rotor) to facilitate tracking/capturing of the spinning rotor by the wireless device 250 (e.g., via its camera or the like) or other external device. In some embodiments, the processor may correlate the motor spin direction with information from a sensor of the UAV, such as an upward vertical motion or force imparted on the motor, a downward vertical motion or force imparted on the motor, or a generation of positive lift, or of negative lift.

In determination block 1006, the processor may determine whether the motor is spinning in a correct direction. A “correct” direction may include a direction of spin that correlates with an expected spin direction when power is applied to the motor. In some embodiments, the expected direction of spin may be a spin direction that generates positive lift, or which generates negative lift, or which imparts an upward vertical motion or force on the motor, or which imparts a downward vertical motion or force on the motor. In some embodiments the processor may determine that the motor is spinning in the correct direction by detecting a rotational frequency-per-applied power of the motor and determining whether the detected rotational frequency-per-applied power matches (e.g., within a threshold level) an expected rotational frequency-per-applied power of the motor. In some embodiments, the processor may use information from the external device (e.g., the wireless device 250), such as the captured series of images or video, to determine, whether the direction in which the motor is spinning correlates with the expected direction of spin.

In response to determining that the motor is not spinning in the correct direction (i.e., determination block 1006=“No”), the processor may perform the operations described regarding block 306 (FIGS. 3 and 6).

In response to determining that the motor is spinning in the correct direction (i.e., determination block 1006=“Yes”), the processor may perform the operations described regarding block 322 (FIGS. 3 and 6).

The method 1000 (or blocks thereof) may be repeated for one or more additional motors of the UAV.

The embodiments and embodiments enable the processor of the UAV to determine that a motor spins in the proper direction for flight. Determining the proper motor spin direction improves the operation of the UAV because a proper connection of the wires of various models of motor may not be uniform or intuitive, and the wires of a new motor may be connected incorrectly. While some motor models utilize polarized motor connectors, the same problem arises when interchangeable electronic speed controllers are used. In addition, the methods improve the operation of the UAV because a user may find it difficult or impossible to determine the spin direction of a motor based only on the model or version of such motor, or based on visual inspection alone. Installing and directly observing the spin direction of a rotor (i.e., of a motor driving the rotor) may be inconvenient, since mistakes can only be corrected by disassembly, rewiring and/or re-soldering the motor. In addition, most UAV motors spin so rapidly that visual determination of the spin direction may be difficult and may not be safe.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 300, 600, and 1000 may be substituted for or combined with one or more operations of the methods 300, 600, and 1000, and vice versa.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the spirit or scope of the claims. Thus, the present disclosure is not intended to be limited to the embodiments shown herein but is to be accorded the widest scope consistent with the following claims and the principles and novel features disclosed herein.

1. A method of controlling a motor of an unmanned aerial vehicle (UAV), comprising:
applying a power to a motor of the UAV in a rotational direction;
detecting a rotational frequency-per-applied power of the motor in response to applying the power in the rotational direction;
determining whether the detected rotational frequency-per-applied power in the rotational direction matches an expected rotational frequency-per-applied power within a specified tolerance; and
selecting the rotational direction in response to determining that the detected rotational frequency-per-applied power in the rotational direction matches the expected rotational frequency-per-applied power within the specified tolerance.

2. The method of claim 1, further comprising:
applying a second power to the motor in a second rotational direction; and
detecting a rotational frequency-per-applied power of the motor in response to applying the second power in the second rotational direction;
wherein determining whether the detected rotational frequency-per-applied power in the rotational direction matches an expected rotational frequency-per-applied comprises:
determining which of the detected rotational frequency-per-applied power in the rotational direction and the detected rotational frequency-per-applied power in the second rotational direction is a closer match to the expected rotational frequency-per-applied power; and
wherein selecting the rotational direction in response to determining that the detected rotational frequency-per-applied power in the rotational direction matches the expected rotational frequency-per-applied power comprises:
selecting the rotational direction of the closer match of the detected rotational frequency-per-applied power in the rotational direction and the detected rotational frequency-per-applied power in the second rotational direction to the expected rotational frequency-per-applied power.

3. The method of claim 2, further comprising:
determining whether the closer match is determinable; and
applying the power to the motor in the rotational direction in response to determining that the closer match is not determinable.

4. The method of claim 1, further comprising:
detecting that a new motor is coupled to the UAV; and
detecting a model of the new motor when the new motor is detected, wherein the expected rotational frequency-per-applied power is based on the detected model of the motor.

5. The method of claim 1, further comprising:
detecting a model of the motor when the new motor is detected, wherein the expected rotational frequency-per-applied power is based on the detected model of the motor.

6. The method of claim 1, further comprising:
storing the selected rotational direction in a memory;
retrieving the stored rotational direction from the memory; and
applying power to the motor based on the retrieved rotational direction.

7. The method of claim 6, wherein the memory is a memory of the UAV.

8. The method of claim 6, wherein the memory is a memory of a wireless device associated with the UAV.

9. The method of claim 1, further comprising:
applying power to the motor using the selected rotational direction;
analyzing the motor spin direction in response to applying the power to the motor; and
determining whether the motor is spinning in a correct rotational direction that correlates with an expected spin direction based on the analyzed motor spin direction.

10. A method of controlling a motor of an unmanned aerial vehicle (UAV), comprising:
applying a power to a motor of the UAV in a rotational direction;
detecting a vertical motion in response to applying the power in the rotational direction;
determining whether the detected vertical motion is positive when the power is applied in the rotational direction; and
selecting the rotational direction in response to determining that the detected vertical motion is positive when the power is applied in the rotational direction.

11. The method of claim 10, further comprising:
applying a second power to the motor in a second rotational direction;
detecting a vertical motion in response to applying the second power in the second rotational direction;
determining whether the detected vertical motion is positive when the second power is applied in the second rotational direction in response to determining that the vertical motion is not positive when the power is applied in the rotational direction; and
selecting the second rotational direction in response to determining that the detected vertical motion is positive when the second power is applied in the second rotational direction.

12. The method of claim 11, further comprising:
applying the power to the motor in the rotational direction in response to determining that the vertical motion is not positive when the power is applied in the second rotational direction.

13. The method of claim 10, further comprising:
storing the selected rotational direction in a memory;
retrieving the stored rotational direction during a power-up of the UAV; and
applying power to the motor using the retrieved rotational direction.

14. The method of claim 10, wherein the memory is a memory of the UAV.

15. The method of claim 10, wherein the memory is a memory of a wireless device associated with the UAV.

16. The method of claim 10, further comprising:
detecting that a new motor is coupled to the UAV; and
detecting a model of the new motor when the new motor is detected, wherein determining whether the detected vertical motion is positive when the power is applied in the rotational direction is based on the detected model of the motor.

17. The method of claim 10, further comprising:
detecting a model of the motor when the new motor is detected, wherein determining whether the detected vertical motion is positive when the power is applied in the rotational direction is based on the detected model of the motor.

18. The method of claim 10, further comprising:
applying power to the motor using the selected rotational direction;
analyzing the motor spin direction in response to applying the power to the motor; and
determining whether the motor is spinning in a correct rotational direction that correlates with an expected spin direction based on the analyzed motor spin direction.

19. An unmanned aerial vehicle (UAV), comprising:
a motor; and
a processor coupled to the motor and configured to:
apply a power to the motor in a rotational direction;
detect a rotational frequency-per-applied power of the motor in response to applying the power in the rotational direction;
determine whether the detected rotational frequency-per-applied power in the rotational direction matches an expected rotational frequency-per-applied power within a specified tolerance; and
select the rotational direction in response to determining that the detected rotational frequency-per-applied power in the rotational direction matches the expected rotational frequency-per-applied power within the specified tolerance.

20. The UAV of claim 19, wherein the processor is further configured to:
apply a second power to the motor in a second rotational direction; and
detect a rotational frequency-per-applied power of the motor in response to applying the second power in the second rotational direction;
determine which of the detected rotational frequency-per-applied power in the rotational direction and the detected rotational frequency-per-applied power in the second rotational direction is a closer match to the expected rotational frequency-per-applied power, and
select the rotational direction of the closer match of the detected rotational frequency-per-applied power in the rotational direction and the detected rotational frequency-per-applied power in the second rotational direction to the expected rotational frequency-per-applied power.

21. The UAV of claim 20, wherein the processor is further configured to:
determine whether the closer match is determinable; and
apply the power to the motor in the rotational direction in response to determining that the closer match is not determinable.

22. The UAV of claim 19, wherein the processor is further configured to:
detect a model of the motor when the new motor is detected, wherein the expected rotational frequency-per-applied power is based on the detected model of the motor.

23. The UAV of claim 19, further comprising a memory coupled to the processor, wherein the processor is further configured to:
store the selected rotational direction in a memory;
retrieve the stored rotational direction from the memory; and
apply power to the motor based on the retrieved rotational direction.

24. The UAV of claim 19, wherein the processor is further configured to:
apply a power to the motor using the selected rotational direction;
analyze the motor spin direction in response to applying the power to the motor; and
determine whether the motor is spinning in a correct rotational direction that correlates with an expected spin direction based on the analyzed motor spin direction.

25. An unmanned aerial vehicle (UAV), comprising:
a motor; and
a processor coupled to the motor and configured to:
apply a power to a motor of the UAV in a rotational direction;
detect a vertical motion in response to applying the power in the rotational direction;
determine whether the detected vertical motion is positive when the power is applied in the rotational direction; and
select the rotational direction in response to determining that the detected vertical motion is positive when the power is applied in the rotational direction.

26. The UAV of claim 25, wherein the processor is further configured to:
apply a second power to the motor in a second rotational direction;
detect a vertical motion in response to applying the second power in the second rotational direction;
determine whether the detected vertical motion is positive when the second power is applied in the second rotational direction in response to determining that the vertical motion is not positive when the power is applied in the rotational direction; and
select the second rotational direction in response to determining that the detected vertical motion is positive when the second power is applied in the second rotational direction.

27. The UAV of claim 26, wherein the processor is further configured to:
apply the power to the motor in the rotational direction in response to determining that the vertical motion is not positive when the power is applied in the second rotational direction.

28. The UAV of claim 25, further comprising a memory coupled to the processor, wherein the processor is further configured to:
store the selected rotational direction in a memory;
retrieve the stored rotational direction during a power-up of the UAV; and
apply power to the motor using the retrieved rotational direction.

29. The UAV of claim 25, wherein the processor is further configured to:
detect a model of the motor when the new motor is detected; and
determine whether the detected vertical motion is positive when the power is applied in the rotational direction based on the detected model of the motor.

30. The UAV of claim 25, wherein the processor is further configured to:
apply power to the motor using the selected rotational direction;
analyze the motor spin direction in response to applying the power to the motor; and
determine whether the motor is spinning in a correct rotational direction that correlates with an expected spin direction based on the analyzed motor spin direction.
